(19) United States
(12) Patent Application Publication
(10) Pub. No.: US 2010/0271339 A1
(43) Pub. Date: Oct. 28, 2010

(54) DEVICE FOR FACILITATING ACTIVE DATA ENTRY

(76) Inventor: Robert Lee Helm, Lansing, MI (US)

Correspondence Address: HOWARD & HOWARD ATTORNEYS PLLC, 450 West Fourth Street, Royal Oak, MI, 48067, US

(21) Appl. No.: 12/766,256

(22) Filed: Apr. 23, 2010

Related U.S. Application Data
(60) Provisional application No. 61/214,413, filed on Apr. 23, 2009.

(51) Int. Cl. G06F 3/033

(52) U.S. Cl. 345/179

(57) ABSTRACT

A device for facilitating communication with a data input device which includes an elongated body member with a concave closed end portion and a tubular portion including an open end defining a hollowed out finger receiving cavity therein and an elongated projecting member resistant to axial deformation and supported by the body member, the projecting member including a proximal end connected with the concave closed end portion of the body member and a distal portion, the distal portion having a planar contact surface defined thereon, wherein the proximal end of the projecting member is at a location that is radially offset from the apex of the concave end portion.

### CROSS REFERENCE TO RELATED APPLICATIONS

This application claims priority to U.S. Provisional Application Ser. No. 61/214,413, filed Apr. 23, 2009, the disclosure of which is incorporated herein by reference in its entirety.

### BACKGROUND

Small or miniature size computing devices, particularly portable devices such as personal digital assistants (PDA) and cellular devices capable of text messaging and text based communication, are now widely used throughout the world. These small or miniature devices include correspondingly small or miniature sized data input mechanisms. Thus, the keyboard and mouse or touchscreen devices for data entry have been replaced. These devices typically utilize a miniature keypad, a multi-tap data entry mechanism or touchscreen enabled devices that provide displays of buttons or virtual representations of keypads. It should be readily apparent that since the size of the average human finger has stayed the same, the miniature size of such input mechanisms often makes it burdensome to enter data accurately and quickly.

### SUMMARY

In some embodiments, the invention is directed to a device for facilitating active data entry or communication with a data input device that comprises an elongated body member with a closed end portion and a tubular portion including an open end defining a hollowed out finger receiving cavity therein, the open end of the tubular portion including a peripheral lip defining a finger entry port aperture for finger access to the finger receiving cavity; and an elongated projecting member resistant to axial deformation and supported by the body member, the projecting member including a proximal portion connected with the body member and a distal portion, the distal portion having a planar contact surface defined thereon, the planar contact surface being configured and dimensioned to correspond with the data input device, wherein the longitudinal axis defined by the elongated body member and the longitudinal axis defined by the elongated projecting member transverse one another within the finger receiving cavity in at least one plane.

In some embodiments, the closed end portion of the elongated body member described above comprises a generally concave shape. The proximal portion of the elongated projecting member may be connected with the generally concave end portion.

In some embodiments, the finger receiving cavity described above further comprises a finger tip engaging region configured to correspond to the shape of the finger tip portion of a human finger.

In some embodiments, the finger receiving cavity described above further comprises a fingernail receiving slot defined in the inner wall of the cavity.

In some embodiments, the inner wall of the finger receiving cavity is constructed of a material which includes anti-microbial properties.

In some embodiments, the elongated body member is tapered from the peripheral lip to the closed end portion.

In some embodiments, the elongated projecting member is tapered from the proximal end to the distal end.

In some embodiments, the elongated projecting member is generally frusto-conical in shape.

The invention may also be directed to a device for facilitating communication with a data input device which comprises an elongated body member with a concave closed end portion and a tubular portion including an open end defining a hollowed out finger receiving cavity therein, the open end of the tubular portion defining a finger entry port aperture for finger access to the finger receiving cavity; and an elongated projecting member resistant to axial deformation and supported by the body member, the projecting member including a proximal end connected with the concave closed end portion of the body member and a distal portion, the distal portion having a planar contact surface defined thereon, wherein the proximal end of the projecting member is at a location which is radially offset from the apex of the concave end portion.

In some embodiments, the elongated body member described above is constructed of a thermoplastic elastomer.

In some embodiments, the contact portion described above is configured and dimensioned to correspond with the data input device.

In some embodiments, the finger receiving cavity described above is configured and dimensioned to receive an average-sized human finger therein, such as the average-sized male or female human thumb.

In some embodiments, the open end of the tubular portion described above further comprises a peripheral lip of greater thickness.

In some embodiments, the finger receiving cavity described above further comprises a fingernail receiving slot defined in the inner wall of the cavity.

In some embodiments, the inner wall of the finger receiving cavity is constructed of a material which includes anti-microbial properties.

In some embodiments, the elongated body member described above is tapered from the peripheral lip to the closed end portion.

In some embodiments, the elongated projecting member described above is tapered from the proximal end to the distal end.

In some embodiments, the elongated projecting member is generally frusto-conical in shape.

In some embodiments, the longitudinal axis defined by the elongated body member and the longitudinal axis defined by the elongated projecting member in the device described above transverse one another within the finger receiving cavity in at least one plane.

Other aspects of the invention will become apparent by consideration of the detailed description and accompanying drawings.

### BRIEF DESCRIPTION OF THE DRAWINGS

FIG. 1 is a side perspective view of a device according to some embodiments of the invention.

FIG. 2 is another side perspective view of the device shown in FIG. 1.

FIG. 3 is a front perspective view of the device shown in FIG. 1.

FIG. 4 is a cross sectional view of the device shown in FIG. 1 taken generally along a longitudinal plane as indicated by line 4-4 in FIG. 2.

FIG. 5 is a cut away view of a portion of the front of the device shown in FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected” and “supported” or variations thereof are used broadly and encompass both direct and indirect mountings, connections, supports, moldings and couplings. Further, such terms are not restricted to physical or mechanical connections or couplings. It should also be understood that references to “keypad” or “button” herein includes physical keypads and buttons, as may found on PDA's, miniature computing devices, mobile phones and the like, and also includes virtual representations thereof as well as any other virtual representation of icons, graphics or other displays on a graphical user interface which may be selected by the user of a touchscreen enabled device.

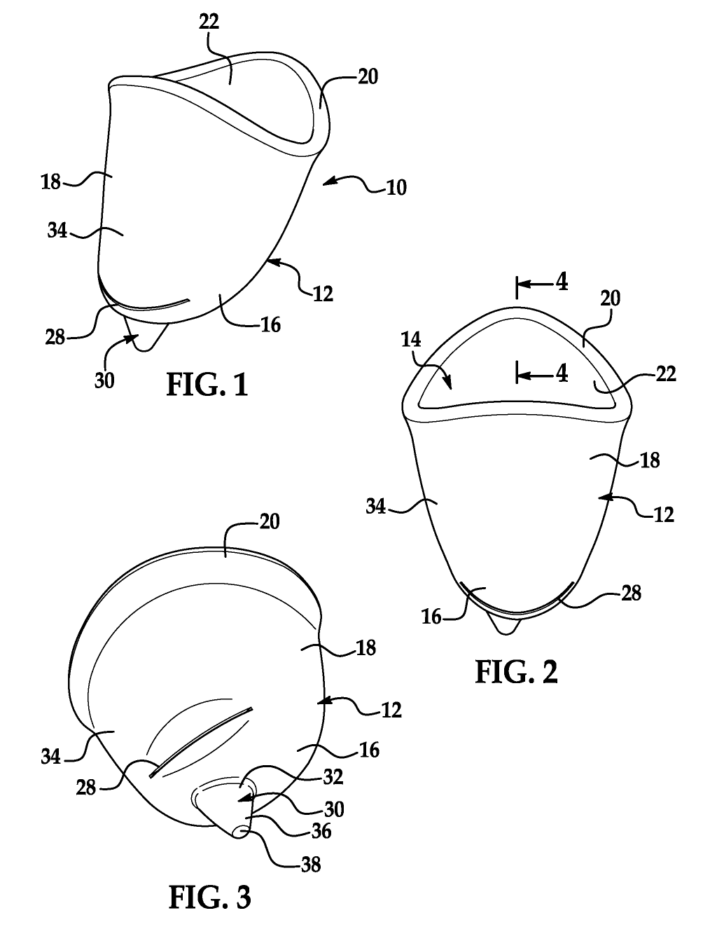

FIGS. 1-5 illustrate a device for facilitating data input 10 according to one embodiment of the invention. Device 10 includes a body member 12 having a hollowed out portion defining a finger receiving cavity 14 therein. In this embodiment, finger receiving cavity 14 is further defined by a generally concave closed end portion 16 connected with a tubular portion 18 having an outer peripheral lip 20, which forms a generally circular finger entry port aperture 22 to provide finger access to finger receiving cavity 14, among other things.

In some embodiments, body member 12 is configured and dimensioned to fit comfortably over the distal end of a user's finger, that is, the finger tip of any finger. In this embodiment, cavity 14 includes a finger tip engaging region 24 shaped to accommodate the shape of the thumb finger and peripheral lip 20 is curved to fit adjacent to the first knuckle (i.e., first knuckle from the finger tip). In some embodiments, tubular portion 18 may be further elongated to extend over a greater portion of the user's finger. In this embodiment, however, finger tip engaging region 24 has an internal diameter less than the internal diameter associated with finger entry port aperture 22, with tubular portion 18 gradually decreasing in internal diameter or being generally tapered from the peripheral lip 20 to concave portion 16 or otherwise minoring the overall shape of an average-sized human finger.

Body member 12 and cavity 14 may be configured and dimensioned to be worn on all or other particular fingers, such as the right and/or left pointer, thumb, pinkie, ring or middle fingers of a user. Body member 12 and cavity 14 may also be configured and dimensioned in particular sizes, such as small, medium or large. It is envisioned that device 10 may be marketed and sold as pairs, such as a pair of devices configured for the right and left hand thumbs.

Cavity 14 of body member 12 may include an inner wall 26 that is coated with or otherwise made of a substance having antibacterial and/or antimicrobial properties, such as for example, plastic materials containing silver ions or thermoplastic elastomer with an anti-microbial additive such as Alphasan marketed by the Milliken Chemical Company of Spartanburg, S.C. (www.alphasan.com or www.millikenchemica.com). Inner surface 26 may be made wholly or partially of a material having a high coefficient of friction or tackiness, such as cellular rubber, or may include surficial features such as indentations, depressions, ridges or the like, which facilitate the ongoing secure engagement of device 10 on the user's finger. Peripheral lip 20 may be helpful in the removal of device 10 from the user's finger, among other things.

In this embodiment, cavity 14 further includes a fingernail receiving slot 28 which accommodates and protects fingernails of varying length as well as facilitates a secure engagement of device 10 on the user's finger, among other things. In this embodiment, fingernail receiving slot 28 extends into and through inner wall 26 of cavity 14. In other embodiments, fingernail receiving slot 28 may be defined as a groove in the inner wall 26 without extending through to concave portion 16.

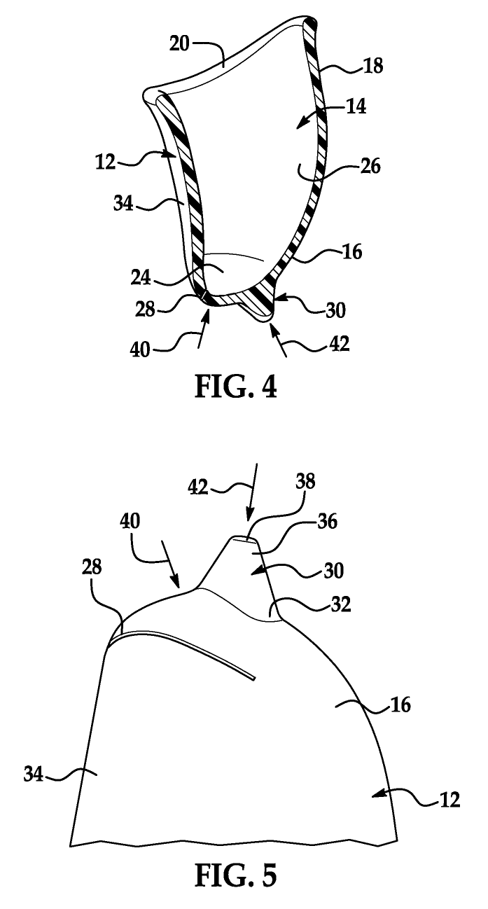

Body member 12 supports an elongated projecting member or projection 30 extending outwardly from concave portion 16 at a transverse angle with respect thereto. Projection 30 is connected at a proximal base end 32 thereof with outer surface 34 of body member 12. A distal end 36 of projection 30 includes a data inputting contact surface 38 defined thereon. In this embodiment, projection 30 is connected with body member 12 via proximal end 32 at a location adjacent to concave portion 16, yet radially offset, apart or distant from an apex of the concave portion 16, which is generally indicated by arrow 40 in FIG. 4 and FIG. 5. Thus, the longitudinal axis defined by projection 30, which is generally represented by arrow 42 in FIG. 4 and FIG. 5, transverses a longitudinal axis defined by body member 12 which extends through apex as generally shown by arrow 40 at a point that resides within cavity 14.

It should be understood that these axes are not shown in the figures other than as generally indicated by arrows 42 and 44, and are used merely for illustrative purposes to promote a better understanding of the description herein. Furthermore, in other embodiments, proximal end 32 of projection 30 may be concentric with the apex along arrow 40, and/or the longitudinal axis defined by projection 30 may be axial with the longitudinal axis defined by body member 12.

In some embodiments, the degree of radially offset may be varied depending on the particular finger upon which device 10 is intended for use. For example, the relative offset from the apex may be greater on a device such as device 10 which is configured for the thumb rather than for the pinkie finger due to the natural downward pivoting motion of the thumb as compared with the forward extension of the pinkie finger. The offset of proximal end 32 of projection 30 may vary in both radius and radial direction relative to the apex. For example, the offset may be downward and favor one side rather than being generally at a latitudinal midpoint on closed end portion 16, depending on whether device 10 is for the thumb of the right hand or the thumb of the left hand. Thus, in such embodiments, the longitudinal axis defined by projection 30 transverses the longitudinal axis defined by body member 12 in multiple planes. It should be understood that various configurations may be employed for purposes such as increasing visibility of the underlying keypad or touchscreen option or button while using device 10 to actuate that option or button via contact surface 38.

In this embodiment, contact surface 38 is substantially planar for facilitating increased surface area contact with a keypad button or virtual representation thereof on a data input device, among other things. Contact surface 38 may be planar or arcuate, and may further include surficial features such as indentations, depressions ridges or the like to facilitate efficient contact over multiple keystrokes, among other things. Projection 30 may be constructed of a variety of materials. In some embodiments, projection 30 is a rubber or material which is reinforced for rigidity and structural integrity. In other embodiments, projection 30 is constructed of a material which resists axially deformation from forces applied to contact surface 38. Projection 30 may be of any shape, such as cylindrical, frusto-conical, triangular or rectangular, as well as tapered or not tapered, to provide increased support and resiliency against forces applied to contact surface 38 when actuating real or virtual keypad buttons, among other things, using device 10.

In some embodiments, body member 12 may support a plurality of spatially distanced projections 30 along concave portion 16 to facilitate data input by the front and opposing sides of fingers, among other things. It should be readily apparent that projection 30 may be of varying length as necessary, such as to suit the intended use or manufacturing constraints.

In operation, a user places a device 10 on an appropriate finger and may then use it to depress buttons, actuate representations of buttons or other graphics on touch screens or otherwise communicate through any data input device that is touch sensitive or relies on contact for entering data.

Data input facilitating device 10 can comprise a combination of rigid or flexible materials, such as metal or plastic, some which has mentioned above, which resist permanent deformation. For example, body member 12 may be a porous or non-porous flexible material, including without limitation, a variety of polymers, such as elastomers. Body member 12 can comprise a natural rubber or a synthetic rubber (e.g., butyl, or other types of rubber). In some embodiments, the flexible material can include latex, urethane, thermoplastic elastomer (TPE) or a thermoplastic elastomer blend, polyvinyl chloride (PVC) and any combination thereof. Contact surface 38 may be constructed or incorporate a variety of materials, such as those which improve rigidity, structural integrity or facilitate detection thereof when used in connection with touch screens and the like. Body member 12 and/or contact surface 38 may have a variety of slogans, logos, decorative features such as rhinestones or even jewels disposed on its outer surface 34. Device 10 may be fabricated via injection molding or other conventional forming methods.

It should be readily apparent that device 10 can be constructed wholly or partially of any shape desired, including, for example, spherical, conical, egg shaped or combinations thereof.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A device for facilitating communication with a data input device, comprising:
an elongated body member with a closed end portion and a tubular portion including an open end defining a hollowed out finger receiving cavity therein, the open end of the tubular portion including a peripheral lip defining a finger entry port aperture for finger access to the finger receiving cavity; and
an elongated projecting member resistant to axial deformation and supported by the body member, the projecting member including a proximal portion connected with the body member and a distal portion, the distal portion having a planar contact surface defined thereon, the planar contact surface being configured and dimensioned to correspond with the data input device,
wherein the longitudinal axis defined by the elongated body member and the longitudinal axis defined by the elongated projecting member transverse one another within the finger receiving cavity in at least one plane.

2. A device as recited in claim 1, wherein the closed end portion of the elongated body member comprises a generally concave shape.

3. A device as recited in claim 2, wherein the proximal portion of the elongated projecting member is connected with the generally concave end portion.

4. A device as recited in claim 1, wherein the finger receiving cavity further comprises a finger tip engaging region configured to correspond to the shape of the finger tip portion of a human finger.

5. A device as recited in claim 1, wherein the finger receiving cavity further comprises a fingernail receiving slot defined in the inner wall of the cavity.

6. A device as recited in claim 1, wherein the inner wall of the finger receiving cavity is constructed of a material which includes anti-microbial properties.

7. A device as recited in claim 1, wherein the elongated body member is tapered from the peripheral lip to the closed end portion.

8. A device as recited in claim 1, wherein the elongated projecting member is tapered from the proximal end to the distal end.

9. A device as recited in claim 1, wherein the elongated projecting member is generally frusto-conical in shape.

10. A device for facilitating communication with a data input device, comprising:
an elongated body member with a concave closed end portion and a tubular portion including an open end defining a hollowed out finger receiving cavity therein, the open end of the tubular portion defining a finger entry port aperture for finger access to the finger receiving cavity; and
an elongated projecting member resistant to axial deformation and supported by the body member, the projecting member including a proximal end connected with the concave closed end portion of the body member and a distal portion, the distal portion having a planar contact surface defined thereon,
wherein the proximal end of the projecting member is at a location which is radially offset from the apex of the concave end portion.

11. A device as recited in claim 10, wherein the elongated body member is constructed of a thermoplastic elastomer.

12. A device as recited in claim 10, wherein the contact portion is configured and dimensioned to correspond with the data input device.

13. A device as recited in claim 10, wherein the finger receiving cavity is configured and dimensioned to receive an average size human finger therein.

14. A device as recited in claim 10, wherein the open end of the tubular portion further comprises a peripheral lip of greater thickness.

15. A device as recited in claim 10, wherein the finger receiving cavity further comprises a fingernail receiving slot defined in the inner wall of the cavity.

16. A device as recited in claim 10, wherein the inner wall of the finger receiving cavity is constructed of a material which includes anti-microbial properties.

17. A device as recited in claim 10, wherein the elongated body member is tapered from the peripheral lip to the closed end portion.

18. A device as recited in claim 10, wherein the elongated projecting member is tapered from the proximal end to the distal end.

19. A device as recited in claim 10, wherein the elongated projecting member is generally frusto-conical in shape.

20. A device as recited in claim 10, wherein the longitudinal axis defined by the elongated body member and the longitudinal axis defined by the elongated projecting member transverse one another within the finger receiving cavity in at least one plane.
